(19) United States
(12) Patent Application Publication
(10) Pub. No.: US 2026/0065830 A1
(43) Pub. Date: Mar. 5, 2026

(54) LED DISPLAY DEVICE AND METHOD OF CONTROLLING THE SAME

(71) Applicant: LX Semicon Co.,Ltd., Daejeon (KR)

(72) Inventors: Yoon Soo SHIN, Daejeon (KR); Jang Su KIM, Daejeon (KR); Jong Min LEE, Daejeon (KR); Ji Hwan KIM, Daejeon (KR); Jin Ho CHOI, Daejeon (KR)

(73) Assignee: LX Semicon Co.,Ltd., Daejeon (KR)

(21) Appl. No.: 19/317,726

(22) Filed: Sep. 3, 2025

(30) Foreign Application Priority Data
Sep. 4, 2024 (KR) 10-2024-0119691
Jun. 16, 2025 (KR) 10-2025-0078556

(51) Int. Cl. G09G 3/20; G09G 3/32

(52) U.S. Cl. CPC G09G 3/2074; G09G 3/32; G09G 2310/0286; G09G 2320/0257

(57) ABSTRACT

A light emitting diode (LED) display device according to one embodiment of the present invention includes a plurality of LED sub-pixels, N channel groups configured to supply a current to the plurality of LED sub-pixels, and M scan groups configured to perform a scanning operation. Particularly, the M scan groups include, for example, controllers, each of which corresponds to one preset scan line.

### CROSS-REFERENCE TO RELATED APPLICATIONS

This application claims the benefit of the Korean Patent Applications No. 10-2024-0119691 filed on Sep. 4, 2024 and No. 10-2025-0078556 filed on Jun. 16, 2025, which are hereby incorporated by reference in their entireties.

### BACKGROUND

### Field of the Invention

Embodiments of the present invention relate to a light emitting diode (LED) driver and a display device including the same. More particularly, embodiments of the present invention are applicable to all display devices of which low-grayscale image quality needs to be improved.

### Discussion of the Related Art

Display panels may be implemented in various ways. For example, display panels may be classified as liquid-crystal display (LCD) display panels or light emitting diode (LED) display panels.

Mini LEDs or micro LED elements are used in LED display panels. Accordingly, the required number of modular LED elements may be disposed. Therefore, large display devices such as digital signage may be easily implemented.

However, as LED display devices become larger, operation of a large number of channels becomes necessary. Further, due to this, a problem of reduced channel driving capability due to LED parasitic capacitance is occurring. Particularly, there is also a disadvantage in that low-grayscale image quality characteristics deteriorate.

### SUMMARY

One object of one embodiment of the present invention is to improve channel driving capability by reducing light emitting diode (LED) parasitic capacitance by solving the above-described problems of the related art.

An LED display device according to one embodiment of the present invention for solving the above-described technical problems includes a plurality of LED sub-pixels, N channel groups configured to supply a current to the plurality of LED sub-pixels, and M scan groups configured to perform a scanning operation.

Particularly, the M scan groups may include controllers, each of which corresponds to one preset scan line. More specifically, for example, the controllers mapped with the scan lines in a one-to-one manner may be included in the scan groups.

The controller may further include, for example, a first voltage regulator for setting a first voltage level and a second voltage regulator for setting a second voltage level.

The controller may further include, for example, a first switch that determines whether a voltage supplied through the first voltage regulator is transmitted through a specific scan line, and a second switch that determines whether a voltage supplied through the second voltage regulator is transmitted through the specific scan line.

The M scan groups may include, for example, at least a first scan line, a second scan line, and a third scan line.

When the first scan line is in a turned-on state, the second scan line and the third scan line may be in a turned-off state.

Both a voltage supplied through a 1-1 voltage regulator and a voltage supplied through a 2-1 voltage regulator are supplied through the second scan line, and both a voltage supplied through a 1-2 voltage regulator and a voltage supplied through a 2-2 voltage regulator are supplied through the third scan line.

A method of controlling an LED display device according to one embodiment of the present invention may include supplying a current to a plurality of LED sub-pixels using N channel groups and performing a scanning operation using M scan groups.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a configuration diagram of a display device according to one embodiment of the present invention;

FIG. 2 is a view for describing the scan frequency of a light emitting diode (LED) driver according to one embodiment of the present invention;

FIG. 3 is a configuration diagram of the LED driver and a display panel according to one embodiment of the present invention;

FIG. 4 is an enlarged view of some components shown in FIG. 3;

FIG. 5A is a view showing a controller shown in FIG. 4 in more detail;

FIG. 5B is a circuit diagram showing a first switch (520) shown in FIG. 5A in more detail;

FIG. 6 is a view for describing low-grayscale image quality that is improved when using the controller shown in FIG. 5A;

FIGS. 7A and 7B is a view for describing the difference between the related art and the present invention in terms of parasitic capacitance;

FIG. 8 is a view for describing the difference between the related art and the present invention in terms of target channel voltage levels; and

FIG. 9 shows a timing diagram according to one embodiment of the present invention.

### DETAILED DESCRIPTION OF THE DISCLOSURE

Throughout the present specification, identical reference numbers refer to substantially identical components. In the following description, detailed descriptions of those not related to the essential components of the present invention and components and functions known in the technical field of the present invention may be omitted. The meanings of the terms described in the present specification should be understood as follows.

The advantages and features of the present invention and the methods for achieving them will become clear with reference to the embodiments described in detail below together with the accompanying drawings. However, the present invention is not limited to the embodiments disclosed below, but may be implemented in various different forms, and these embodiments are provided only to ensure that the disclosure of the present invention is complete and to fully inform a person having ordinary skill in the art to which the present invention pertains of the scope of the invention, and the present invention is defined only by the scope of the claims.

The shapes, sizes, ratios, angles, numbers, and the like shown in the drawings for describing embodiments of the present invention are exemplary, and therefore the present invention is not limited to the illustrated details. Throughout the present specification, identical reference numerals refer to identical components. In addition, in describing the present invention, when it is determined that a detailed description of a related known technology may unnecessarily obscure the gist of the present invention, the detailed description thereof is omitted.

When the terms “include,” “have,” “composed of,” and the like described in the present specification are used, other parts may be added unless “only” is used. When a component is expressed in the singular, the plural is included unless otherwise stated.

When interpreting a component, an error range is included even when there is no separate explicit description.

When describing a positional relationship, for example, when the positional relationship between two portions is described as “above,” “upper portion of,” “lower portion of,” “next to,” and the like, one or more other parts may be located between the two parts, unless “immediately” or “directly” is used.

When describing a temporal relationship, for example, when temporal continuity is described as “after,” “following,” “next to,” “before,” and the like, the case can also include cases where it is not continuous, as long as ‘immediately’ or ‘directly’ is not used.

Although the terms first, second, and the like are used to describe various components, these components are not limited by these terms. These terms are only used to distinguish one component from another. Therefore, a first component described below may also be a second component within the technical concept of the present invention.

The term “at least one” should be understood to include all possible combinations of one or more of the relevant items. For example, the meaning of “at least one of a first item, a second item, and a third item” can mean not only each of the first item, the second item, or the third item, but also any possible combination of two or more among the first item, the second item, and the third item.

The features of each of the various embodiments of the present invention can be partially or wholly combined with each other, and various technical connections and operations are possible, and each embodiment can be implemented independently of each other or implemented together in a related relationship.

Hereinafter, embodiments of the present specification will be described in detail with reference to the accompanying drawings.

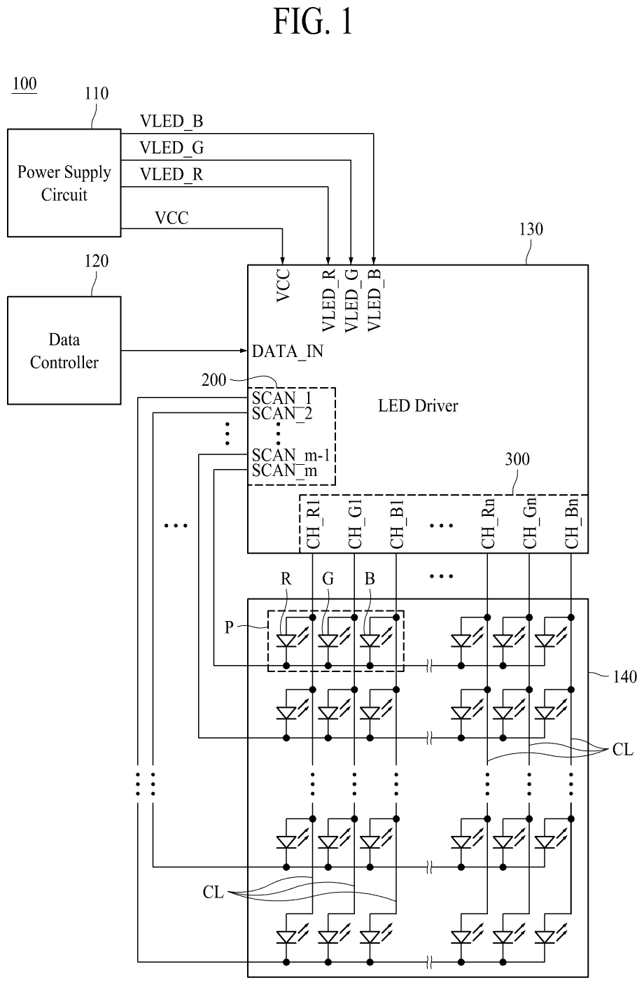

FIG. 1 is a configuration diagram of a display device according to one embodiment of the present invention.

As shown in FIG. 1, a display device 100 may include a power supply circuit 110, a data controller 120, an LED driver 130, a display panel 140, scan lines SL, and channel lines CL.

The power supply circuit 110 may supply power to the LED driver 130. The power supply circuit 110 may supply at least a portion of driving power VCC and LED power VLED to the LED driver 130.

The driving power VCC may be a power source for the operation of the display panel 140.

The LED power VLED may be power for adjusting the brightness or color of a pixel P. The LED power VLED may include red LED power VLED_R supplied to a sub-pixel expressing red, green LED power VLED_G supplied to a sub-pixel expressing green, and blue LED power VLED_B supplied to a sub-pixel expressing blue. However, this is only an example, and the type of LED power VLED may vary depending on the embodiment.

The data controller 120 may be an LED pixel data controller. The data controller 120 may obtain data related to the brightness or color of pixels P included in the display panel 140 and transmit the obtained data to the LED driver 130. Alternatively, the data controller 120 may transmit at least some of scan signals and data signals to the LED driver 130.

The scan signal may be a signal for supplying the driving power VCC to the display panel 140 through the scan line SL. The data signal may be a signal for supplying the LED power VLED to the display panel 140 through the channel line CL.

The LED driver 130 may generate a scan signal based on data related to the brightness or color of the pixels P obtained from the data controller 120. Alternatively, the LED driver 130 may receive the scan signal from the data controller 120.

The LED driver 130 may include a scan group 200 and a channel group 300.

The scan group 200 may include a first scan terminal to an m^{th} scan terminal SCAN_1, SCAN_2, . . . , SCAN_m−1, and SCAN_m.

The scan group 200 may supply the driving power VCC to the display panel 140 based on the scan signal.

The scan group 200 may be connected to the display panel 140 through one scan line SL. The scan group 200 may be sequentially connected to the display panel 140 in a vertical direction through one scan line SL. The scan group 200 may supply the driving power VCC to the display panel 140 through one scan line SL.

The channel group 300 may include a first red channel terminal CH_R1, a first green channel terminal CH_G1, a first blue channel terminal CH_B1, . . . , an n^{th} red channel terminal CH_Rn, an n^{th} green channel terminal CH_Gn, and an n^{th} blue channel terminal CH_Bn.

The channel group 300 may supply the LED power VLED to the display panel 140 based on the data signal.

The channel group 300 may be connected to the display panel 140 through one channel line CL. The channel group 300 may be sequentially connected to the display panel 140 in a horizontal direction through one channel line CL. The channel group 300 may supply the LED power VLED to the display panel 140 through one channel line CL.

The display panel 140 may include the plurality of pixels P.

Each of the plurality of pixels P may include a plurality of sub-pixels R, G, and B. For example, a pixel P may include a sub-pixel R expressing red, a sub-pixel G expressing green, and a sub-pixel B expressing blue. However, the types of sub-pixels included in the pixel P are not limited thereto and may vary depending on the embodiment.

Each of the sub-pixels may include an LED. That is, the display panel 140 may be an LED display panel.

The plurality of pixels P may be connected through the scan lines SL in the horizontal direction. Additionally, the plurality of pixels P may be connected through the channel lines CL in the vertical direction. Accordingly, the plurality of pixels P may be disposed to form a matrix.

Pixels P connected through one scan line SL in the horizontal direction may receive the driving power VCC output from the same scan group 200.

Pixels P connected through one channel line CL in the vertical direction may receive the LED voltage VLED output from the same channel group 300.

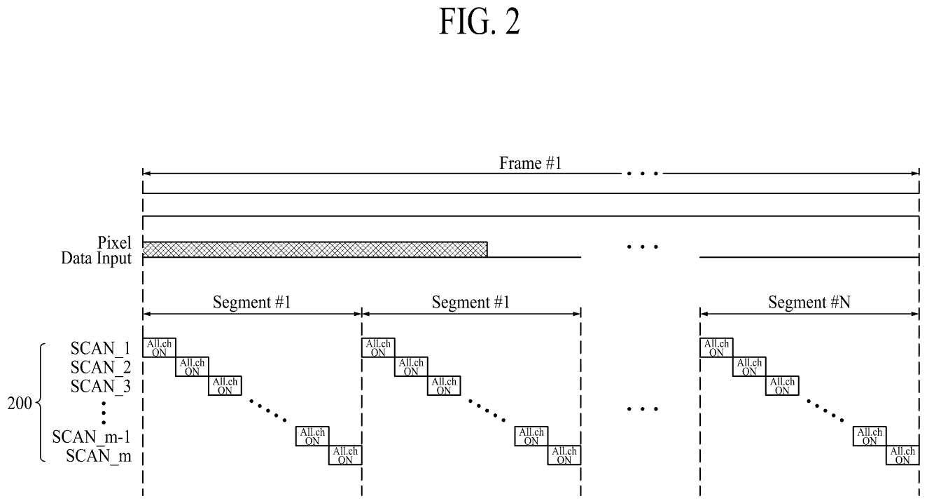

FIG. 2 is a view for describing the scan frequency of the LED driver according to one embodiment of the present invention.

A frame may refer to each image that constitutes a video. One frame may be divided into a plurality of segments.

One segment may be a unit in which one scan operation cycle is performed. The scan operation may be an operation performed by turning a scan switch included in a scan group on and then off. The one scan operation cycle may mean that the scan operation is performed sequentially once from the first scan terminal SCAN_1 to the m^{th} scan terminal SCAN_m.

However, the scan operation according to the embodiment may not be sequentially performed from the first scan terminal SCAN_1 to the m^{th} scan terminal SCAN_m. For example, the scan operation sequence may be determined in consideration of PCB routing.

A scan frequency may be, for example, the number of scan operations per second.

When a frame frequency is 60 Hz and there are 64 segments per frame, 3,840 scan operations per second may be performed. That is, the scan frequency may be 3,840 Hz.

The higher the scan frequency, the smoother the screen appears and the better the image quality appears.

However, as the scan frequency increases, the power consumption of the LED driver 130 may also increase.

This is because a pre-charge operation is performed between scan operations to prevent ghosting, and a current is consumed each time the pre-charge operation is performed.

Ghosting may refer to a phenomenon in which pixels P connected to a scan group 200 that is not in a scanning operation are illuminated. Accordingly, the desired screen may not be accurately displayed, and image quality may appear to deteriorate.

The pre-charge may mean an operation of charging a first capacitor C1 connected to a scan line whose scan operation has ended before a scan operation of another scan line is initiated. The pre-charge may occur between the end of a scan operation and the start of the next scan operation.

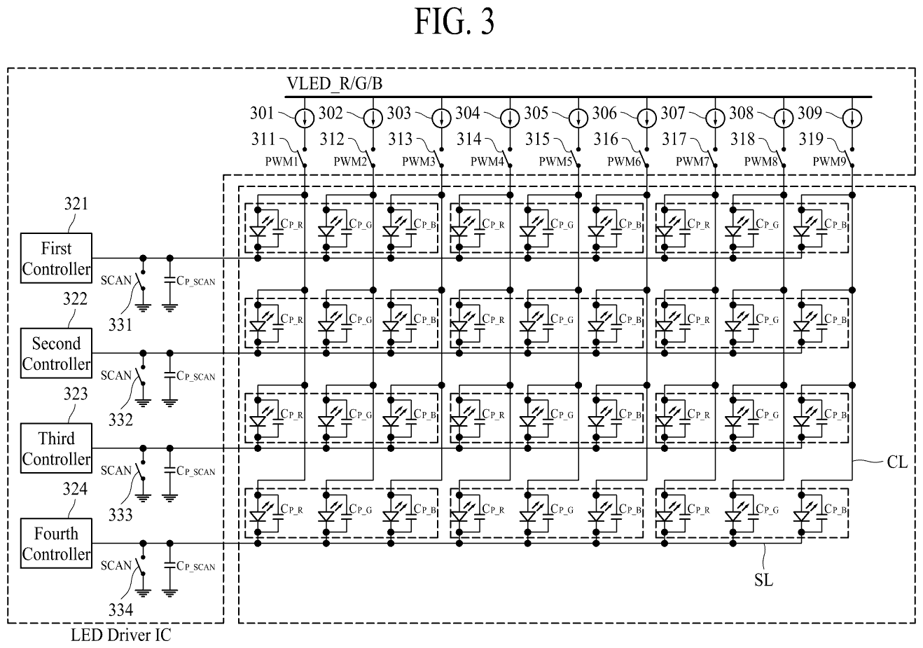

FIG. 3 is a configuration diagram of the LED driver and the display panel.

The display device may include the LED driver and the display panel as shown in FIG. 3.

The display panel may include a plurality of pixels P and a plurality of capacitors (not shown).

The plurality of capacitors may be parasitic capacitors of an LED module. The plurality of capacitors may be capacitors that form capacitance inside the display device depending on the operation of the LED driver or the display panel. These capacitors may not be physical capacitors but virtual capacitors.

The plurality of capacitors may be divided into a plurality of first capacitors C1 that form capacitance between a plurality of LEDs and the scan switch, and a second capacitor C2 that forms capacitance between the plurality of LEDs and a channel current source.

The current of I_CH1 301 may be supplied to a pixel by the operation of PWM1 311.

The current of I_CH2 302 may be supplied to a pixel by the operation of PWM2 312.

The current of I_CH3 303 may be supplied to a pixel by the operation of PWM3 313.

The current of I_CH4 304 may be supplied to a pixel by the operation of PWM4 314.

The current of I_CH5 305 may be supplied to a pixel by the operation of PWM5 315.

The current of I_CH6 306 may be supplied to a pixel by the operation of PWM6 316.

The current of I_CH7 307 may be supplied to a pixel by the operation of PWM7 317.

The current of I_CH8 308 may be supplied to a pixel by the operation of PWM8 318.

The current of I_CH9 309 may be supplied to a pixel by the operation of PWM9 319.

Although nine channel lines CL are shown in FIG. 3, this is merely exemplary, and the present invention is not limited thereto.

A voltage may be supplied to a pixel through a first scan line by the operation of SCAN1 331.

A voltage may be supplied to a pixel through a second scan line by the operation of SCAN2 332.

A voltage may be supplied to a pixel through a third scan line by the operation of SCAN3 333.

A voltage may be supplied to a pixel through a fourth scan line by the operation of SCAN4 334.

Although four scan lines SL are shown in FIG. 3, this is merely exemplary, and the present invention is not limited thereto.

Meanwhile, in order to eliminate ghosting (unintentional lighting of LED pixels or the like), which is one of the image quality issues of LED display products, a pre-charge operation is required at the scan terminal.

For example, LED (R/G/B) pixels should be maintained in a reverse biased state except when a scan terminal circuit is actually turned on.

However, according to the related art, since there was a problem that parasitic capacitances operating as a plurality of loads connected in the channel lines were visible, the slope of the pulse-width modulation (PWM) output became gentle, and thus it was difficult to drive low-gray 1T grayscale data.

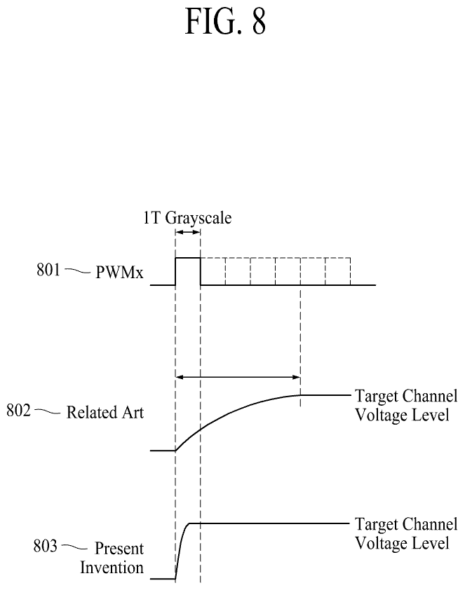

Here, 1T grayscale may mean, for example, one unit block of the PWM driving signal shown in FIG. 8A.

In order to solve the above problem, according to one embodiment of the present invention, as shown in FIG. 3, a first controller 321, a second controller 322, a third controller 323, and a fourth controller 324 were additionally designed for each scan line.

The controller located on each of the scan lines may additionally include a switch for 1TD operation. Here, the 1TD operation may mean, for example, controlling one unit block of the PWM driving signal shown in FIG. 8A.

For example, when driving PWM on a channel line, a scan voltage is additionally increased by ΔV by the 1TD switch included in each of the controllers.

When designed in this way, a first node (scan line) of the LED parasitic capacitance may rapidly increase by ΔV, and a second node (channel line) may also rapidly increase by ΔV, resulting in a technical effect of improving the slope of the channel voltage by approximately 500 times compared to the conventional method.

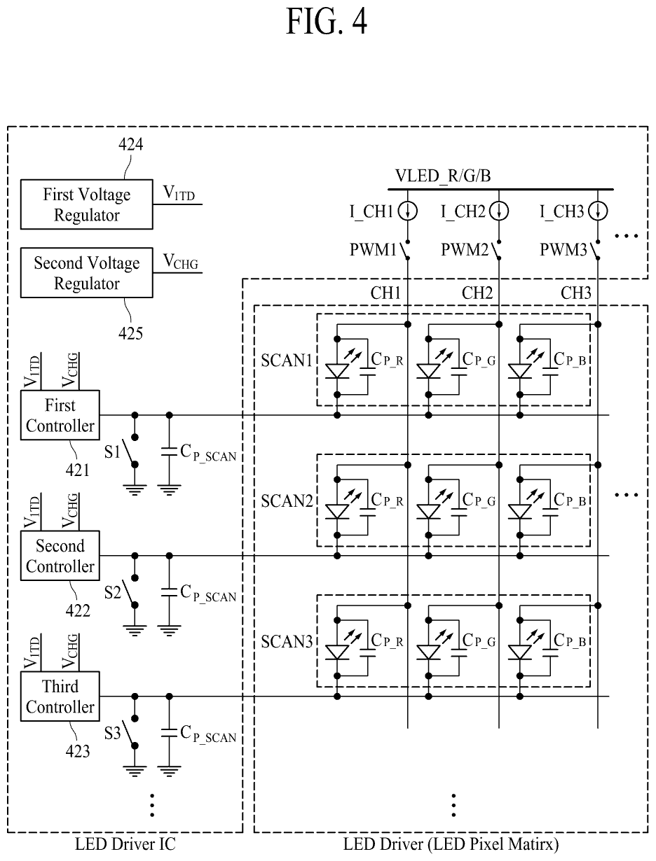

FIG. 4 is an enlarged view of some components shown in FIG. 3.

Although it is assumed that 9 channel lines are connected and 4 scan lines are connected in FIG. 3, it is assumed that 3 channel lines are connected and 3 scan lines are connected in FIG. 4. However, the above-described numbers are merely exemplary and do not limit the scope of the present invention.

As shown in FIG. 4, an LED display device according to one embodiment of the present invention may include a current source I_CH[N:1] for supplying a current to each LED sub-pixel.

Furthermore, the LED display device may include a scan switch S[M:1] for a scanning operation.

Further, the LED display device may include a first voltage regulator (for example, reference numeral 424 shown in FIG. 4) for setting a low-gray voltage level, a second voltage regulator (for example, reference numeral 425 shown in FIG. 4) for setting a scan terminal-off voltage, and a controller.

As shown in FIG. 4, a first controller 421, a second controller 422, a third controller 423, and the like are located on each of the scan lines. However, each of the controllers 421, 422, and 423 shown in FIG. 4 may be designed to include the above-described first and second voltage regulators.

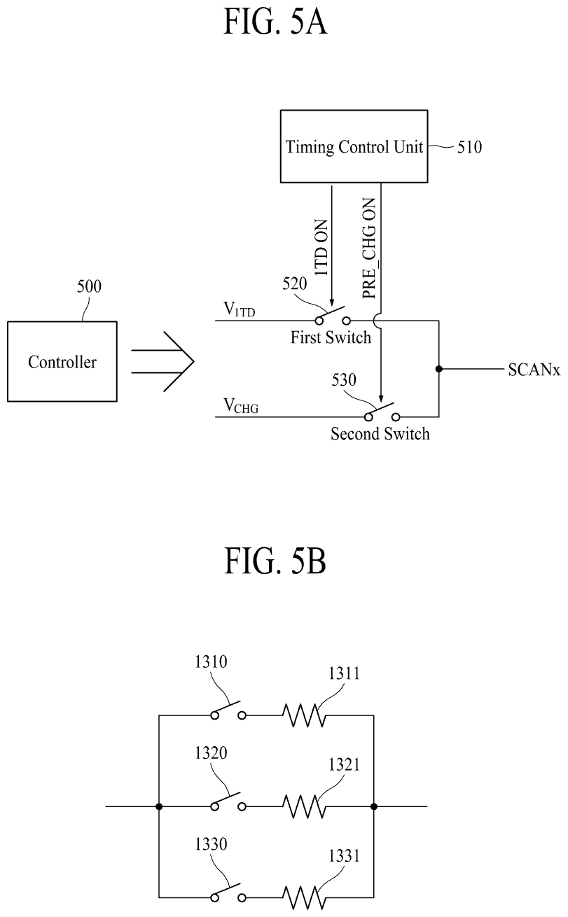

Meanwhile, the detailed configuration of the controllers 421, 422, and 423 shown in FIG. 4 will be described in more detail with reference to FIG. 5A below.

FIG. 5A is a view showing a controller shown in FIG. 4 in more detail.

As shown in FIG. 5A, a controller 500 according to one embodiment of the present invention may include a timing control unit 510, a first switch 520, and a second switch 530.

Under the control of the timing control unit 510, the first switch 520 or the second switch 530 may be changed to the turned-on state.

For example, when the timing control unit 510 applies an arbitrary command (for example, 1TD ON as shown in FIG. 5A) to the first switch 520, a first voltage (for example, V_{1TD} as shown in FIG. 5A) may be output through the scan line. Furthermore, it is also possible to adjust the input time of an arbitrary command (for example, 1TD ON) shown in FIG. 5A.

Meanwhile, when the timing control unit 510 applies another command (for example, PRE_CHG ON shown in FIG. 5A) to the second switch 530, a second voltage (for example, V_{CHG} shown in FIG. 5A) may be output through the scan line.

FIG. 5B is a circuit diagram showing the first switch 520 shown in FIG. 5A in more detail.

It is also possible to additionally adjust the voltage slew rate by implementing the first switch 520 shown in FIG. 5A with the circuit diagram shown in FIG. 5B.

For example, it is assumed that a first resistor 1311 is set to 10 ohms, a second resistor 1321 is set to 100 ohms, and a third resistor 1331 is set to 1 k ohms, but the present invention is not necessarily limited to this.

In this case, when a 1-1 switch 1310 is turned on and a 1-2 switch 1320 and a 1-3 switch 1330 are turned off, it is possible to increase to a target voltage level in a relatively short time.

On the other hand, when the 1-3 switch 1330 is turned on and the 1-2 switch 1320 and the 1-1 switch 1310 are turned off, it is possible to increase to the target voltage level through a relatively long delay.

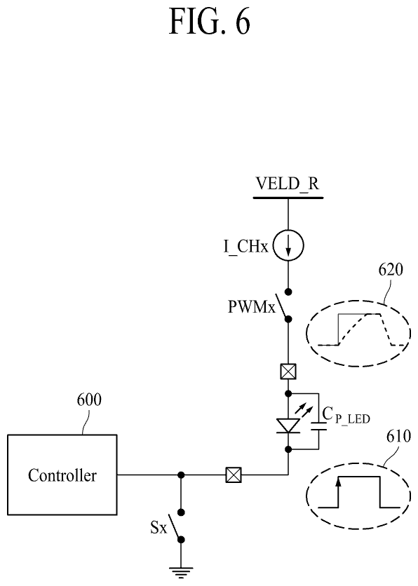

The process by which the controller shown in FIG. 5A operates will be described below with reference to FIG. 6.

FIG. 6 is a view for describing low-grayscale image quality that is improved when using the controller shown in FIG. 5A.

For example, when driving a channel PWM using the PWMx switch shown in FIG. 6, a scan voltage is rapidly increased by ΔV by a controller 600.

One node (scan line side) of an LED parasitic capacitance (C_{P_LED} shown in FIG. 6) rapidly increases by ΔV (reference numeral 620 shown in FIG. 6), and the other node (channel line side) also rapidly increases by ΔV (reference numeral 610 shown in FIG. 6).

Therefore, an effect of reducing parasitic capacitance (C_{P_LED} shown in FIG. 6) occurs.

Further, a channel terminal voltage level quickly reaches the target voltage level LED VF.

Therefore, PWM 1T driving is possible, and low-grayscale image quality is improved.

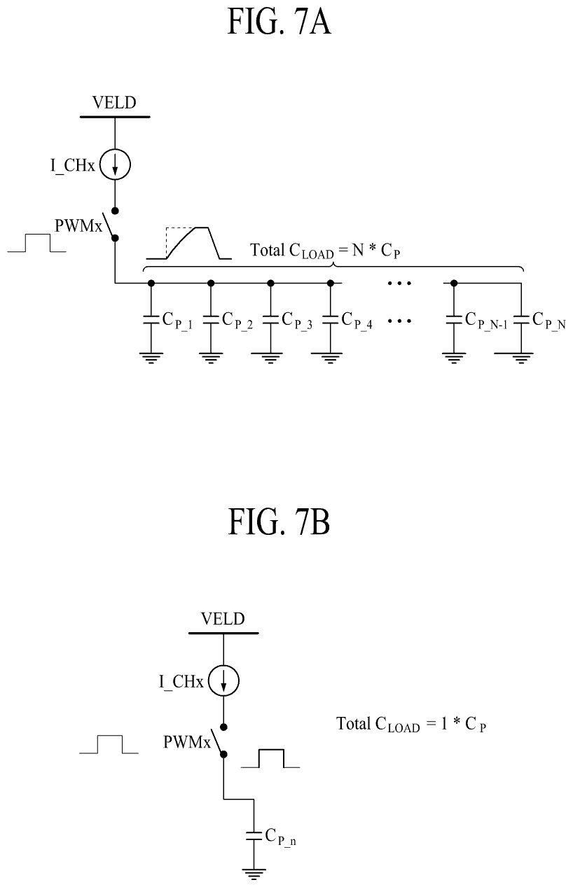

FIGS. 7A and 7B is a view for describing the difference between the related art and the present invention in terms of parasitic capacitance.

In the related art, since a controller is not provided for each scan line, there is a problem that a scan voltage does not rise quickly when driving a channel PWM, as shown in FIG. 7A. This is because the total parasitic capacitance (Total C_{LOAD}) of a channel group is N*Cp.

On the other hand, according to the above-described embodiment of the present invention, since the controller is provided for each scan line, there is an advantage of a rapid increase in scan voltage when driving the channel PWM, as shown in FIG. 7B. This is because the total parasitic capacitance (Total C_{LOAD}) of the channel group is 1*Cp. That is, there is an advantage in that the parasitic capacitance value of the channel group is reduced.

FIG. 8 is a view for describing the difference between the related art and the present invention in terms of the target channel voltage level.

801 in FIG. 8 show a PWMx driving signal operating on a channel line. One block represents 1T grayscale, which is low-level.

As described above, in the related art, the parasitic capacitance value is relatively very high. Therefore, in order to increase to the target voltage level, PWM 1T or more is required, as shown in 802 in FIG. 8.

On the other hand, according to one embodiment of the present invention, the parasitic capacitance value is reduced. Therefore, in order to increase to the target voltage level, PWM 1T or higher is sufficient to achieve a technical effect, as shown in 803 in FIG. 8.

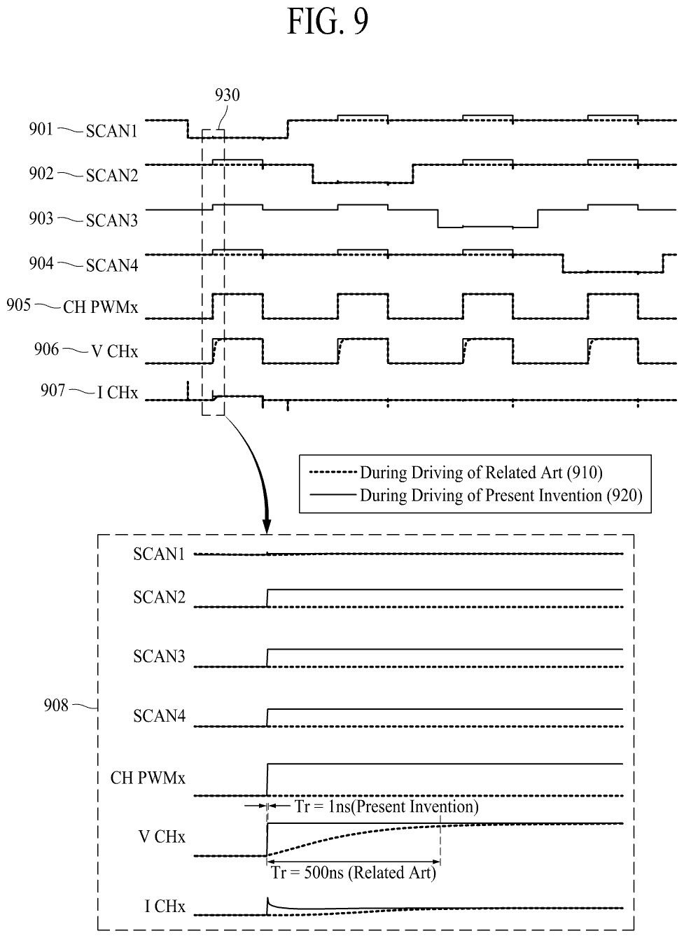

FIG. 9 shows a timing diagram according to one embodiment of the present invention. Additional descriptions are provided with reference to previous drawings.

First, in order to eliminate ghosting (that is, the unwanted lighting of LED pixels), which is a picture quality issue in LED display devices, a pre-charge voltage needs to be applied to the end of the scan line.

However, in the related art, there was a problem in that it was difficult to implement low-grayscale image quality because parasitic capacitance increased at the output terminal of the channel line. In order to quickly reach the target voltage required for the output terminal of the channel line, according to one embodiment of the present invention, an additional voltage is applied to the scan line in the turned-off state in addition to the voltage for pre-charge.

901 in FIG. 9 is a timing diagram of a first scan line, which can be controlled by, for example, the first controller 421 of FIG. 4.

902 in FIG. 9 is a timing diagram of a second scan line, which can be controlled by, for example, the second controller 422 of FIG. 4.

903 in FIG. 9 is a timing diagram of a third scan line, which can be controlled by, for example, the third controller 423 of FIG. 4.

904 in FIG. 9 is a timing diagram of a fourth scan line (not shown in FIG. 4), which may be controlled, for example, by a fourth controller (not shown in FIG. 4).

905 in FIG. 9 is a timing diagram for turning on/off a PWM switch of an arbitrary channel line. Here, the PWM switch may mean, for example, at least one of PWM1, PWM2, or PWM3 shown in FIG. 4.

906 in FIG. 9 is a view showing a voltage change in a channel line corresponding to 905 in FIG. 9, and 907 in FIG. 9 is a view showing a current change in a channel line corresponding to 905 in FIG. 9.

First, when the first scan line (see 901 in FIG. 9) is turned on, for example, the voltage drops to a ground level.

On the other hand, scan lines other than the first scan line are turned off, and a voltage V_{CHG} (for example, 2.5 V) for pre-charge is still applied. This voltage V_{CHG} for pre-charge may be provided by the second voltage regulator (for example, reference numeral 425 in FIG. 4) located inside each controller connected to the end of each scan line.

Further, as shown in 905 in FIG. 9, when the PWM switch of an arbitrary channel line is changed to the turned-on state, an additional voltage V_{1TD} of 0.5 V is added to the second scan line (see 902 in FIG. 9), the third scan line (see 903 in FIG. 9), and the fourth scan line (see 904 in FIG. 9), which were in the turned-off state, so that a total of 3.0 V (that is, 2.5 V+0.5 V=3.0 V) is applied. This additional voltage V_{1TD} may be provided by the first voltage regulator (for example, reference numeral 424 in FIG. 4) located inside each controller connected to the end of each scan line.

As shown in 902, 903 and 904 in FIG. 9, a voltage (for example, 2.5 V) for pre-charge is applied in both the present invention and the related art.

However, as shown in 905 in FIG. 9, when the PWMx switch of a specific channel line is changed to the turned-on state, there is no voltage change in the scan line according to the related art (910) as shown in 902, 903 and 904 in FIG. 9. Accordingly, as shown in 908 in FIG. 9, the time (Tr, rising time) for rising to the target voltage of the output terminal of the specific channel line is delayed by 500 ns, which causes a problem in that PWM switching suitable for low grayscale is virtually impossible.

On the other hand, as shown in FIG. 9E, when the PWMx switch of a specific channel line is changed to the turned-on state, as shown in 902, 903 and 904 in FIG. 9, according to one embodiment (920) of the present invention, the voltage (0.5 V) for low grayscale in the scan line is additionally increased. Accordingly, as shown in 908 in FIG. 9, the time for rising to the target voltage of the output terminal of the specific channel line is shortened to 1 ns, which has the technical effect of enabling PWM switching suitable for low grayscale.

That is, as a result of the simulation comparison, the rising slope of the target voltage increased by more than 500 times, and 1T (for example, 10 ns) PWM driving was possible, resulting in a technical effect of improving low-grayscale implementation characteristics.

Those skilled in the art will appreciate that the present invention can be implemented in other specific forms without changing the technical idea or essential features thereof.

Additionally, at least a portion of the methods described in the present specification may be implemented using one or more computer programs or components. This component may be provided as a series of computer instructions through a computer-readable medium or a machine-readable medium including volatile and non-volatile memories. The above instructions may be provided as software or firmware, and all or part thereof may be implemented in hardware configurations such as ASICs, FPGAs, DSPs, or other similar devices. The above instructions may be configured to be executed by one or more processors or other hardware configurations, wherein the above processors or other hardware configurations perform or are capable of performing all or part of the methods and procedures disclosed in the present specification when executing the above series of computer instructions.

According to one embodiment of the present invention, there is a technical effect of improving channel driving capability by reducing LED parasitic capacitance.

In addition, this also has the advantage of improving the low-grayscale picture quality characteristics of an LED display device.

Further, in addition to the effects of the invention explicitly described herein, technical effects that can be inferred by a person skilled in the art through the present specification and drawings also fall within the scope of rights of the present invention.

Therefore, it should be understood that the above-described embodiments are illustrative in all respects and not restrictive. The scope of the present invention is indicated by the claims described below rather than the detailed description above, and all changes or modifications derived from the meaning and scope of the claims and their equivalent concepts should be interpreted as being included in the scope of the present invention.

What is claimed is:

1. A light emitting diode (LED) display device comprising:
a plurality of LED sub-pixels;
N channel groups configured to supply a current to the plurality of LED sub-pixels; and
M scan groups configured to perform a scanning operation,
wherein the M scan groups include controllers, each of which corresponds to one preset scan line.

2. The LED display device of claim 1, wherein the controller further includes a first voltage regulator for setting a first voltage level and a second voltage regulator for setting a second voltage level.

3. The LED display device of claim 2, wherein the first voltage regulator is used for setting a low-gray voltage level while the second voltage regulator is used for setting a scan terminal-off voltage.

4. The LED display device of claim 3, wherein the controller further includes:
a first switch configured to determine whether a voltage supplied through the first voltage regulator is transmitted through a specific scan line.

5. The LED display device of claim 4, wherein the controller further includes:
a second switch configured to determine whether a voltage supplied through the second voltage regulator is transmitted through the specific scan line.

6. The LED display device of claim 5, wherein the first switch and the second switch include at least one PWM switch.

7. The LED display device of claim 6, wherein the M scan groups include at least a first scan line, a second scan line, and a third scan line.

8. The LED display device of claim 7, wherein, when the first scan line is in a turned-on state, the second scan line and the third scan line are in a turned-off state.

9. The LED display device of claim 8, wherein both a voltage supplied through a 1-1 voltage regulator and a voltage supplied through a 2-1 voltage regulator are supplied through the second scan line.

10. The LED display device of claim 9, wherein both a voltage supplied through a 1-2 voltage regulator and a voltage supplied through a 2-2 voltage regulator are supplied through the third scan line.

11. A method of controlling a light emitting diode (LED) display device, comprising:
supplying a current to a plurality of LED sub-pixels using N channel groups; and
performing a scanning operation using M scan groups,
wherein the M scan groups include controllers, each of which corresponds to one preset scan line.

12. The method of claim 11, wherein the controller further includes a first voltage regulator for setting a first voltage level and a second voltage regulator for setting a second voltage level.

13. The method of claim 12, wherein the first voltage regulator is used for setting a low-gray voltage level while the second voltage regulator is used for setting a scan terminal-off voltage.

14. The method of claim 13, wherein the controller further includes:
a first switch configured to determine whether a voltage supplied through the first voltage regulator is transmitted through a specific scan line.

15. The method of claim 14, wherein the controller further includes:
a second switch configured to determine whether a voltage supplied through the second voltage regulator is transmitted through the specific scan line.

16. The method of claim 15, wherein the first switch and the second switch include at least one PWM switch.

17. The method of claim 16, wherein the M scan groups include at least a first scan line, a second scan line, and a third scan line.

18. The method of claim 17, wherein, when the first scan line is in a turned-on state, the second scan line and the third scan line are in a turned-off state.

19. The method of claim 18, wherein both a voltage supplied through a 1-1 voltage regulator and a voltage supplied through a 2-1 voltage regulator are supplied through the second scan line.

20. The method of claim 19, wherein both a voltage supplied through a 1-2 voltage regulator and a voltage supplied through a 2-2 voltage regulator are supplied through the third scan line.
